(19) United States
(12) Patent Application Publication
(10) Pub. No.: US 2026/0102939 A1
(43) Pub. Date: Apr. 16, 2026

(54) Hand-Held Power Tool and Hand-Held Power Tool Device

(71) Applicant: Robert Bosch GmbH, Stuttgart (DE)

(72) Inventors: Samuel Gaunt, Suffolk (GB); Adrian Coussins, Suffolk (GB); Csaba Szmutko, Miskolc Borsod-Abauj-Zemplen (HU)

(21) Appl. No.: 19/120,778

(22) PCT Filed: Oct. 20, 2023
(86) PCT No.: PCT/EP2023/079238

§ 371 Date: Apr. 13, 2025

(30) Foreign Application Priority Data
Oct. 25, 2022 (DE) 10 2022 211 294.6

(51) Int. Cl. B27G 19/00; B27B 17/08

(52) U.S. Cl. CPC B27G 19/003; B27B 17/083

(57) ABSTRACT

A handheld power tool, in particular a chain saw, includes (i) a hand protection lever, and (ii) at least one mechanical control unit for controlling the movement of the hand protection lever of the handheld power tool. The control unit includes at least one mechanical control element provided to control rotational movement of the hand protection lever by an axial relative movement between the control element and the hand protection lever.

### PRIOR ART

A handheld power tool with a hand protection lever and at least one mechanical control unit has already been proposed for controlling the movement of the hand protection lever of the handheld power tool.

### DISCLOSURE OF THE INVENTION

The invention proceeds from a handheld power tool, in particular a chainsaw, with a hand protection lever and with at least one mechanical control unit for controlling the movement of the hand protection lever of the handheld power tool.

It is proposed that the controller has at least one mechanical control element provided to control a rotational movement of the hand protection lever by an axial relative movement between the control element and the hand protection lever.

Through the design of the handheld power tool according to the invention, the movement control for the hand protection lever can be constructed in a particularly space-saving manner. Advantageously, the control element can be disposed particularly close to the hand protection lever. Advantageously, particularly precise movement control can be achieved. Advantageously, a particularly simple assembly of the control unit can be enabled. The design of the control unit according to the invention, in particular the control element, allows for an improvement in the feel of the unit during operation, in particular during movement of the hand protection lever. By controlling the movement of the hand protection lever by means of the control unit, a particularly comfortable user experience can be realized. Advantageously, a force required to move the hand protection lever can be adjusted and/or set in a manner which uses a particularly simple design and/or in a particularly precise manner. Advantageously, a particularly flexible and/or adjustable control unit can be provided.

Preferably, the handheld power tool is configured as a chainsaw, for example a fuel-powered chainsaw, particularly a gasoline-powered chainsaw, an electric chainsaw, a pneumatic chainsaw, an oil-pressure-powered chainsaw, or the like. Alternatively, however, it is also contemplated that the handheld power tool may be configured as a hedge shear, a drill, an angle grinder, a circular saw, or the like.

The handheld power tool, in particular the chainsaw, is preferably configured as a two-hand chainsaw. Preferably, the handheld power tool, in particular the chainsaw, has two handles. One handle of the two handles is disposed on a side of the handheld power tool facing away from a tool mounting area of the handheld power tool. A tool can preferably be disposed, and in particular is disposed, in the tool mounting area for the handheld power tool. The tool is preferably designed as a chainsaw. However, alternatively, it is also conceivable, in particular as a function of the configuration of the handheld power tool, that the tool is configured as a drill, as a cut-off wheel, as a saw blade, or the like. A throttle lever and/or a throttle lock are preferably disposed on the handle. A further handle of the two handles is preferably configured as a handle bar or a tubular handle. The further handle is disposed between the handle and the tool mounting area. The hand protection lever is in particular provided to protect an operator's hand abutting the further handle, preferably to protect the operator, in particular the operator's hand abutting the further handle or an operator's arm, from contact with the tool. The term “intended” should be understood to mean specifically configured, specifically designed, and/or specifically equipped. An object being “intended” for a specific function is understood to mean that the object fulfills and/or performs this specific function in at least one application and/or operating state. The hand protection lever is in particular disposed between the further handle and the tool mounting area, preferably the tool. The hand protection lever is preferably provided for triggering a brake of the handheld power tool, preferably a chain brake, particularly in the event of an unexpected kick-back of the handheld power tool. The brake is preferably provided to bring the tool, in particular the chainsaw, to a standstill within a fraction of a second, preferably by mechanical and/or electronic means, when the brake is triggered, for example as a result of a kick-back of the handheld power tool. The brake is preferably triggerable by a movement of the hand protection lever, in particular by a rotation of the hand protection lever about an axis of rotation of the hand protection lever, preferably by forward rotation of the hand protection lever about the axis of rotation. For example, the handheld power tool comprises a trigger element which can be actuated by the hand protection lever during a forward rotation of the hand protection lever starting from the neutral position, preferably due to a movement of the hand protection lever to a trigger position. The trigger element is in particular provided for triggering the brake upon actuation of the trigger element. The trigger element can, e.g., be configured as a button, a lever, a gear element or the like. In particular, a movement of the hand protection lever, in particular the forward rotation of the hand protection lever, can be generated by a contact of the hand or the arm of the operator, for example, generated by a kick-back of the handheld power tool, with the hand protection lever, preferably to trigger the brake, in particular to actuate the trigger element. The hand protection lever is preferably rotatably supported on a handheld power tool housing of the handheld power tool, in particular rotatably supported about the axis of rotation. The forward rotation of the hand protection lever is in particular a rotation of the hand protection lever towards the tool mounting area, preferably the tool.

The mechanical control unit is in particular configured as a mechanical movement control unit for the hand protection lever. The mechanical control unit is preferably a purely mechanical gear for controlling the movement of the hand protection lever. The movement behavior of the hand protection lever is determined in particular by the control unit. By rotating the hand protection lever forward by at least 10°, preferably by at least 15°, and preferably by at least 20° around the axis of rotation starting from a neutral position of the hand protection lever, the hand protection lever can preferably be moved to the triggering position in particular relative to the control element, and the brake in particular can be actuated. To move the hand protection lever from the neutral position to the trigger position or from the trigger position to the neutral position, an actuating force must be applied to the hand protection lever. The actuating force for moving the hand protection lever from the neutral position to the trigger position or from the trigger position to the neutral position at an operation point of the hand protection lever is preferably between 20 N and 60 N. Alternatively, however, it is also contemplated that the actuating force for moving the hand protection lever from the neutral position to the trigger position or from the trigger position to the neutral position at an actuation point of the hand protection lever has a value different from a value between 20 N and 60 N. The actuation point is preferably located at a free end of the hand protection lever. A distance of the actuation point to the axis of rotation is preferably between 100 mm and 140 mm, preferably between 110 mm and 130 mm, and particularly preferably 120 mm.

The axial relative movement between the control element and the hand protection lever is preferably at least parallel to the axis of rotation of the hand protection lever. Preferably, the relative movement between the control element and the hand protection lever takes place along the axis of rotation of the hand protection lever. The axis of rotation preferably corresponds to an axial axis of movement of the axial relative movement between the control element and the hand protection lever. Preferably, the hand protection lever is fixed in the axial direction, in particular relative to the handheld power tool housing. The control element is preferably movable in the axial direction, in particular relative to the handheld power tool housing. Alternatively, it is contemplated that the hand protection lever may be movable in the axial direction, particularly relative to the handheld power tool housing, and that the control element may be fixed in the axial direction, in particular relative to the handheld power tool housing. Further, it is contemplated that the hand protection lever and the control element may be movable in the axial direction, in particular relative to the handheld power tool housing. In particular, a rotational movement of the hand protection lever about the axis of rotation generates axial movement of the control element, in particular a movement of the control element along the axis of rotation. The axis of rotation is at least substantially perpendicular to a main extension axis of the handheld power tool. The term “substantially perpendicular” can be understood to mean an alignment of a direction relative to a reference direction, wherein, in particular viewed in a projection plane, the direction and the reference direction enclose an angle of 90° and the angle has a maximum deviation of in particular less than 8°, advantageously less than 5°, and particularly advantageously less than 2°. A “main extension axis” of an object is understood to be an axis running parallel to the longest edge of a smallest geometric cuboid just completely enclosing the object.

Furthermore, it is proposed that the control element comprises at least one control surface configured for axial displacement, in particular for axial displacement of the control element. Advantageously, a particularly precise movement control of the hand protection lever can be carried out. Preferably, an axial relative movement can occur between the control element and the hand protection lever by the interaction of the control surface with the hand protection lever. For example, the hand protection lever interacts with the control surface during a rotary movement of the hand protection lever to generate the axial relative movement between the hand protection lever and the control element. In particular, a main extension plane of the control surface is inclined, and in particular at an angle other than 90°, to the axis of rotation. The “main extension plane” of a structural unit or an element can be understood to mean a plane which is parallel to a largest side surface of a smallest possible imaginary cuboid, which just completely encloses the structural unit, and in particular extends through the center of the cuboid. Preferably, the control surface is planar. Alternatively, however, it is also conceivable that the control surface is at least partially curved. The control surface is preferably part of a ramp element of the control element. The ramp element is preferably configured as triangular, in particular as a two-sided ramp, preferably without a center piece. The control surface corresponds in particular to one side of the ramp, which preferably has two sides. The control element preferably comprises a plurality of ramp elements and/or control surfaces for axial displacement, in particular of the control element. The ramp elements and/or the control surfaces are preferably arranged uniformly, preferably about the axis of rotation, in particular about the axial axis of movement, in particular at least in an operating state. The ramp elements, in particular the control surfaces, preferably form a zigzag-shaped path, in particular about the axial axis of movement and/or the axis of rotation. The respective main extension planes of the control surfaces preferably include a perpendicular angle to the axis of rotation, in particular to the axial axis of movement.

It is further proposed that the control unit comprises at least one further mechanical control element, wherein the control element and the further control element have complementary control surfaces arranged for axial displacement, in particular wherein the further control element is connected to the hand-protection lever in a rotationally fixed manner. Preferably, the further control element is integral with at least a part of the hand protection lever. The term “integral” is to be understood in particular to mean at least a materially bonded connection, for example, by a welding process, an adhesive bonding process, an injection molding process and/or another process that appears to the person skilled in the art to be reasonable, and/or advantageously formed in one piece, for example, by production from a casting and/or by production in a single-component or multi-component injection molding process and advantageously from a single blank. Alternatively, however, it is also conceivable that the further control element is attached to the hand protection lever by means of a screw connection, a latch connection, a clamp connection, a rivet connection, or the like, in particular in a detachable manner. In this context, the term “detachable” is in particular understood to mean “non-destructively separable”. Preferably, the further control element is rigidly connected to the hand protection lever. In particular, the further control element comprises at least one control surface, preferably a plurality of control surfaces. The further control element preferably comprises at least one ramp element, preferably a plurality of ramp elements, comprising the control surface(s) of the further control element. The at least one ramp element of the further control element is in particular configured to be complementary to the at least one ramp element of the control element. In particular, rotational movement of the hand protection lever by interaction of the complementary control surfaces of the control element and the further control element can generate an axial relative movement between the control element and the hand protection lever, in particular the further control element. Preferably, interacting control surfaces, in particular those adjacent to each other, preferably at least their main extension planes, of the control element and the further control element run at least substantially parallel to each other, in particular at least in an operating state. The ramp elements of the control element and/or ramp elements of the further control element each preferably comprise at least two different types of ramp elements that differ in a ramp height and a ramp width. The two types of ramp elements are preferably arranged alternately around the axis of rotation, in particular around the axial axis of movement. The ramp heights of the ramp elements in particular run at least substantially parallel to the axis of rotation, in particular to the axial axis of movement. The ramp widths of the ramp elements run in particular in a circumferential direction that runs in a plane perpendicular to the axis of rotation, in particular to the axial axis of movement. In particular, the further control element rotates about the axis of rotation relative to the control element during a rotational movement of the hand protection lever. Preferably, rotation of the further control element relative to the control element, in particular during a rotation of the hand protection lever relative to the control element about the axis of rotation, generates an axial relative movement between the control element and the hand protection lever, in particular the further control element. In particular, upon transition of the hand protection lever from the neutral position to the trigger position or from the trigger position to the neutral position, a tip of at least one of the ramp elements of the control element crosses a tip of at least one of the ramp elements of the further control element. In particular, upon transition of the hand protection lever from the neutral position to the trigger position or from the trigger position to the neutral position, a tip of at least one of the ramp elements of the type of ramp elements with a relatively larger ramp height of the control element or the further control element crosses a tip of at least one of the ramp elements of the type of ramp elements with a relatively smaller ramp height of the further control element or the control element, respectively.

In addition, it is proposed that the handheld power tool comprises a handheld power tool housing, in particular the already mentioned handheld power tool housing, which comprises at least one mounting unit for mounting at least part of the control unit, in particular for a rotationally fixed mounting of the axially movable control element. Advantageously, a particularly compact arrangement of the control unit in the handheld power tool housing can be achieved. A particularly simple assembly of the control unit, in particular the control element, can be realized in the handheld power tool housing. The mounting unit comprises at least one mounting element for the control element. Preferably, the control element is mounted on the handheld power tool housing in a rotationally fixed manner, in particular about the axis of rotation and/or the axis of movement, by means of the mounting element. Preferably, the control element is movably connected to the handheld power tool housing by means of the mounting unit, in particular the mounting element, in an axial direction, in particular along the axis of movement, preferably along the axis of rotation. The mounting element is preferably formed integrally with at least a portion of the handheld power tool housing. Alternatively, it is also conceivable that the mounting element is attached to the handheld power tool housing by means of a screw connection, a latch connection, a clamp connection, a rivet connection, or the like, in particular, in a detachable manner. The mounting element preferably has a complementary shape to a free end of the control element. The at least one control surface of the control element and/or the at least one ramp element of the control element is disposed at a further free end of the control element. The free end of the control element is in particular disposed facing away from the further free end of the control element. The control element is in particular connected to the support element on one side facing the at least one control surface of the control element and/or the at least one ramp element of the control element. The mounting unit preferably comprises at least one further mounting element for the hand protection lever. Preferably, the hand protection lever is rotatably supported on the handheld power tool housing by means of the mounting unit, in particular the further mounting element, in particular via a mounting sleeve of the hand protection lever, in particular about the axis of rotation and/or the axis of movement. The hand protection lever is in particular attached to the handheld power tool housing by means of a fastening element, for example a screw, a rivet or the like, and/or by means of a clamp connection, a latch connection or the like, preferably via the mounting sleeve. Preferably, the hand protection lever is fixed to the handheld power tool housing by means of the mounting unit, in particular the further mounting element, in the axial direction, in particular along the axis of movement, preferably along the axis of rotation. The further support element is preferably formed integrally with at least a portion of the handheld power tool housing. Alternatively, it is also conceivable that the further mounting element is attached to the handheld power tool housing by means of a screw connection, a latch connection, a clamp connection, a rivet connection, or the like, in particular, in a detachable manner.

It is also proposed that the mounting unit specifies at least one arrangement angle of the control element to the mounting unit. Advantageously, incorrect assembly of the control element on the mounting unit, in particular on the handheld power tool housing, can be counteracted in a manner using a simple design. Advantageously, a particularly simple and/or operator-friendly assembly of the control element can be realized. The functional capability of the control unit can advantageously be supported by the configuration of the mounting unit according to the invention. A particularly reliable control unit may be provided. In particular, the mounting unit, preferably the mounting element, allows the assembly of the control element on the mounting unit only in one or more angular positions of the control element relative to the mounting unit, in particular the mounting element. Preferably, the mounting element comprises a mounting contour, which is in particular configured to be complementary to a mounting connection contour of the control element. The mounting contour of the mounting element preferably allows for assembly of the control element only in one or more angular positions of the control element relative to the mounting unit, in particular the mounting element. The mounting element, in particular the mounting contour, preferably comprises one or more projections, one or more recesses, a combination of these or the like.

It is further proposed that the control unit is provided to permit forward rotation and reverse rotation of the hand protection lever relative to the control element starting from one of the neutral positions of the hand protection lever, in particular, the one already mentioned above. Advantageously, the hand protection lever can be used to fulfil multiple functions due to the configuration of the control unit according to the invention. Advantageously, reverse rotation of the hand protection lever can at least partially absorb an impact on the handheld power tool for example, if the handheld power tool is dropped, upon an impact on the hand protection lever. Advantageously, damage to the handheld power tool and in particular the hand protection lever can be counteracted. A particularly robust hand protection lever can be provided. A particularly high level of occupational safety can be achieved. A particularly durable hand protection lever can be realized. The reverse rotation of the hand protection lever is in particular a rotation of the hand protection lever in a direction opposite to the forward rotation of the hand protection lever. The reverse rotation of the hand protection lever is in particular a rotation of the hand protection lever in a direction away from the tool mounting area. The reverse rotation of the hand protection lever is preferably a rotation of the hand protection lever in the direction of the handle and/or the further handle. The reverse rotation of the hand protection lever is in particular a rotation of the hand protection lever about the axis of rotation.

Furthermore, it is proposed that the control unit comprises at least one spring element, in particular a coil spring, which is provided to apply a force to the control element in the direction of the hand protection lever, wherein in particular the spring element at least partially surroundings the control element in at least one operating state, preferably at least when viewed in a direction parallel to the axis of rotation. Advantageously, a particularly precise movement control of the hand protection lever can be carried out. A particularly comfortable operating feel can be achieved when the hand protection lever is moved by an operator. A particularly high level of operating convenience of the control unit can be achieved. Advantageously, the control unit can be adapted particularly simply, precisely and/or flexibly to different requirements. The spring element is preferably disposed between the control element and the handheld power tool housing at least in an operating state. By the fact that “an object at least substantially completely encloses a further object,” it is to be understood in particular that the further object is enclosed by the object in an angular range of at least 45°, preferably of at least 90°, and particularly preferably of at least 180°. Preferably, the spring element encloses the control element at least substantially completely, in particular when viewed in the direction parallel to the axis of rotation. By the fact that “an object at least substantially completely encloses a further object,” it is to be understood in particular that the further object is enclosed by the object in an angular range of at least 270°, preferably of at least 315°, and particularly preferably of at least 350°. Particularly preferably, the spring element completely encompasses the control element, in particular when viewed in the direction parallel to the axis of rotation. The spring element encloses the mounting element and/or the further support element in particular at least in an operating state, at least in part, preferably at least substantially completely and particularly preferably completely, in particular at least viewed in the direction parallel to the axis of rotation. The spring element preferably encloses the mounting sleeve of the hand protection lever at least partially, preferably at least substantially completely and particularly preferably completely, in particular at least when viewed in the direction parallel to the axis of rotation, in particular the axis of movement. The spring element preferably abuts the handheld power tool housing, in particular with a free end of the spring element. The spring element preferably abuts the control element, preferably an abutment surface of the control element, in particular with a further free end of the spring element. The free end of the spring element is in particular disposed away from the further free end of the spring element. A main extension plane of the abutment surface is at least substantially perpendicular to the axis of rotation and/or the axis of movement. In order to rotate the hand protection lever, in particular from a stationary position of the hand protection lever, an actuating force is preferably to be applied against the spring force that can be generated by the spring element. Preferably, the spring element is configured as a single coil spring. Alternatively, it is also conceivable that the spring element is configured as a torsion spring, a rubber elastic element, or the like. Preferably, the control unit comprises precisely one, in particular the spring element already mentioned above. Alternatively, however, it is also conceivable that the control unit comprises a plurality of spring elements, in particular to apply a force to the control element in the direction of the hand protection lever. A movement of the control element along the axial axis of movement, in particular along the axis of rotation, in particular generates a compression or elongation of the spring element. An axis of elongation and/or compression of the spring element extends at least substantially parallel to the axis of rotation and/or the axial axis of movement at least in an operating state.

It is further proposed that the spring element automatically move the hand protection lever to the neutral position after a reverse rotation of the hand protection lever starting from an, in particular the already mentioned neutral position of the hand protection lever. Advantageously, a particularly high level of operating comfort can be achieved for the handheld power tool, in particular the hand protection lever. Preferably, the control element and the further control element comprise complementary control surfaces which are configured such that automatic movement of the hand protection lever to the neutral position can be generated by means of the spring element after reverse rotation of the hand protection lever starting from the neutral position of the hand protection lever.

In addition, it is proposed that the control unit comprises a stop element, which is provided to limit a reverse rotation of the hand protection lever starting from an, in particular the aforementioned, neutral position of the hand protection lever, in particular by an impact of the hand protection lever against the stop element. Advantageously, a specified minimum distance between the hand protection lever and the further handle can be complied with. Advantageously, an injury to an operator's hand adjoining the further handle can be countered by an impact against the hand protection lever. A particularly high level of occupational safety can be achieved. It is contemplated that reverse rotation of the hand protection lever from the neutral position may be limited by an impact of the hand protection lever and/or the control element against the stop element. In particular, the stop element defines a stop position of the hand protection lever. Preferably, the neutral position is disposed between the trigger position and the neutral position. The neutral position and/or the trigger position are preferably stationary positions of the hand protection lever. To move the hand protection lever from a stationary position of the hand protection lever, preferably the trigger position or the neutral position, an actuation force is to be applied to the hand protection lever. The stationary positions of the hand protection lever, in particular the trigger position and/or the neutral position, are preferably defined by the control unit, in particular the complementary control surfaces of the control element and the further control element.

In addition, it is proposed that the handheld power tool comprises a handheld power tool housing, in particular the already mentioned handheld power tool housing, wherein an outer wall of the handheld power tool housing comprises the stop element. Advantageously, a force acting on the stop element during an impact of the hand protection lever against the stop element can be kept particularly low due to the disposition of the stop element according to the invention. A required reinforcement of the handheld power tool housing in an area of the stop element can be kept particularly low or additional reinforcement of the handheld power tool housing in the area of the stop element can advantageously be omitted entirely. Material may be saved when manufacturing the handheld power tool housing. A particularly affordable handheld power tool housing can be provided in an advantageous manner. For example, the stop element is configured as a stop edge or the like. Preferably, the hand protection lever and/or the control element comprise a stop surface complementary to the stop element.

It is further proposed that the handheld power tool comprises at least one actuating element, in particular a shift element, for triggering a handheld power tool function, in particular a safety function, which can be actuated by reverse rotation of the hand protection lever starting from a neutral position of the hand protection lever. Advantageously, reverse rotation of the hand protection lever from the neutral position may be utilized to trigger a handheld power tool function. Advantageously, a particularly high number of operating options for the handheld power tool by the operator can be achieved. For example, the handheld power tool function may be an additional activation level for commissioning the handheld power tool, a safety function, for example a brake trigger, an automatic system check of the handheld power tool, or the like. Preferably, during reverse rotation of the hand protection lever starting from the neutral position, the operation element can be actuated by the hand protection lever, for example by a protrusion of the hand protection lever or the like. The actuating element is configured as a button, a lever, a gear element or the like, for example.

Furthermore, it is proposed that the actuating element be actuatable from the neutral position of the hand protection lever by a reverse rotation of the hand protection lever to the stop element. Advantageously, undesirable actuation of the actuation element may be at least partially counteracted. It is contemplated that the actuating element is disposed on the stop element. Alternatively, it is contemplated that the actuating element is arranged spaced apart from the stop element.

In addition, it is proposed that at least the control element is arranged at least in a nearby region of one axis of rotation of the hand protection lever, in particular closed about the axis of rotation which has already been mentioned above. A particularly space-saving control unit can be provided in an advantageous manner. A particularly advantageous chain of action can be achieved between the hand protection lever and the control element. Advantageously, particularly precise and/or reliable movement control of the hand protection lever can be realized. The term “nearby region” is in particular understood to mean a region that is a maximum distance from a reference axis that is preferably less than 10 cm, preferably less than 5 cm, and particularly preferably less than 2 cm. The control element preferably encloses the axis of rotation at least substantially completely, preferably completely, in particular when viewed in the direction parallel to the axis of rotation.

Further, the invention proceeds from a handheld power tool device for a handheld power tool according to the invention, in particular a chainsaw, with at least one mechanical control unit, in particular the aforementioned mechanical control unit, to control the movement of an, in particular the aforementioned hand protection lever of the handheld power tool. It is proposed that the control unit comprises at least an, in particular the aforementioned mechanical control element, which is provided for controlling the rotational movement of the hand protection lever by an axial relative movement, at least substantially along an, in particular the aforementioned axis of rotation of the hand protection lever, between the control element and the hand protection lever.

Due to the configuration of the handheld power tool device according to the invention, the movement of a hand protection lever can be controlled in a particularly space-saving manner. Advantageously, the control element can be disposed particularly close to a hand protection lever. Advantageously, particularly precise movement control can be achieved. Advantageously, a particularly simple assembly of the control unit can be enabled. The design of the control unit according to the invention, in particular the control element, allows for an improvement in the feel of the unit during operation, in particular during movement of the hand protection lever. By controlling the movement of the hand protection lever by means of the control unit, a particularly comfortable user experience can be realized. Advantageously, a force required to move the hand protection lever can be adjusted and/or set in a manner which uses a particularly simple design and/or in a particularly precise manner. Advantageously, a particularly flexible and/or adjustable control unit can be provided.

The handheld power tool according to the invention and/or the handheld power tool device according to the invention, should not thereby be limited to the application and embodiment described above. In particular, the handheld power tool according to the invention and/or the handheld power tool device according to the invention can have a number of individual elements, components and units that differs from a number specified herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages follow from the description of the drawings below. An exemplary embodiment of the invention is shown in the drawing. The drawings, the description, and the claims contain numerous features in combination. A person skilled in the art will appropriately also consider the features individually and combine them into additional advantageous combinations.

The figures show:

FIG. 1 a schematic view of a handheld power tool according to the invention,

FIG. 2 a part of the handheld power tool according to the invention in an exploded view,

FIG. 3 a control element of a mechanical control unit of the handheld power tool according to the invention in a perspective view,

FIG. 4 a mounting unit of the handheld power tool according to the invention in a perspective view,

FIG. 5 a part of the handheld power tool according to the invention in a cross-sectional view,

FIG. 6 a hand protection lever of the handheld power tool according to the invention in a neutral position of the hand protection lever,

FIG. 7 the hand protection lever in a triggering position of the hand protection lever,

FIG. 8 the hand protection lever during reverse rotation of the hand protection lever starting from the neutral position, and

FIG. 9 the hand protection lever in a stop position during reverse rotation of the hand protection lever starting from the neutral position.

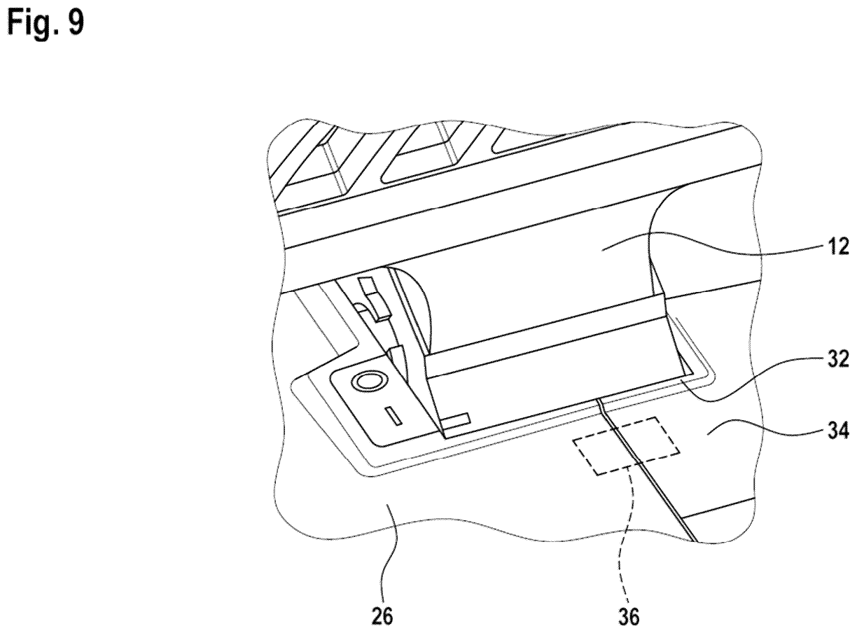

### DESCRIPTION OF THE EXEMPLARY EMBODIMENT

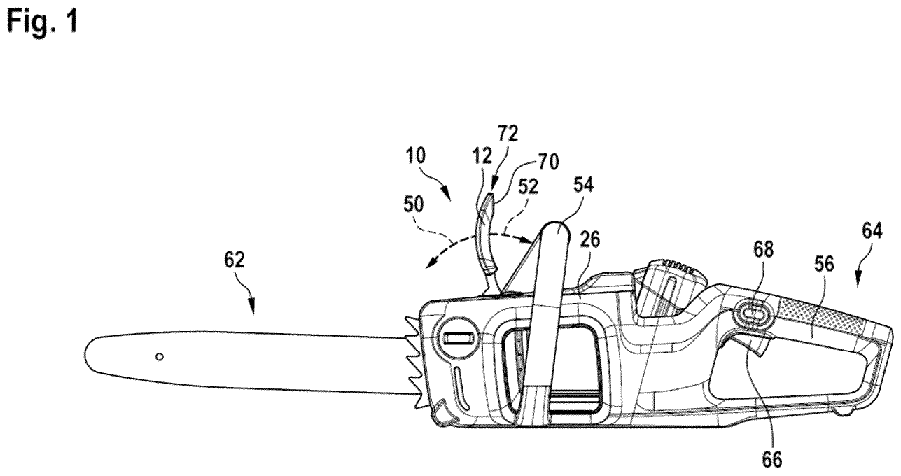

FIG. 1 shows a handheld power tool 10. The handheld power tool 10 is configured as a chainsaw. The handheld power tool 10 is configured as an electric chainsaw, in particular a battery powered chainsaw. Alternatively, it is contemplated that the handheld power tool 10 may be configured as a fuel-powered chainsaw, particularly a gasoline-powered chainsaw, a compressed air-powered chainsaw, an oil-powered chainsaw, a hedge cutter, a drill, a cutter, a hand circular saw, or the like.

The handheld power tool 10 is configured as a two hand chainsaw. The handheld power tool 10 has two handles 54, 56. One handle 54 of the two handles 54, 56 is disposed on a side 64 of the handheld power tool 10 facing away from a tool mounting area 62 of the handheld power tool 10. A tool (not shown here) for the handheld power tool 10 can be disposed, and in particular is disposed in the tool mounting area 62. The tool is designed as a chainsaw. However, alternatively, it is also conceivable, in particular as a function of the configuration of the handheld power tool 10, that the tool is configured as a drill, as a cut-off disc, as a saw blade, or the like. A throttle lever 66 and/or a throttle lock 68 are preferably disposed on the handle 54. A further handle 56 of the two handles 54, 56 is configured as a handle bracket or a tubular handle. The further handle 56 is disposed between the handle 54 and the tool mounting area 62. The further handle 56 is configured as a handle bracket or a tubular handle.

The handheld power tool 10 comprises a hand protection lever 12. The hand protection lever 12 is provided to protect an operator's hand abutting the further handle 56, in particular to protect the operator, preferably the operator's hand or an operator's arm abutting the further handle 56, from contact with the tool.

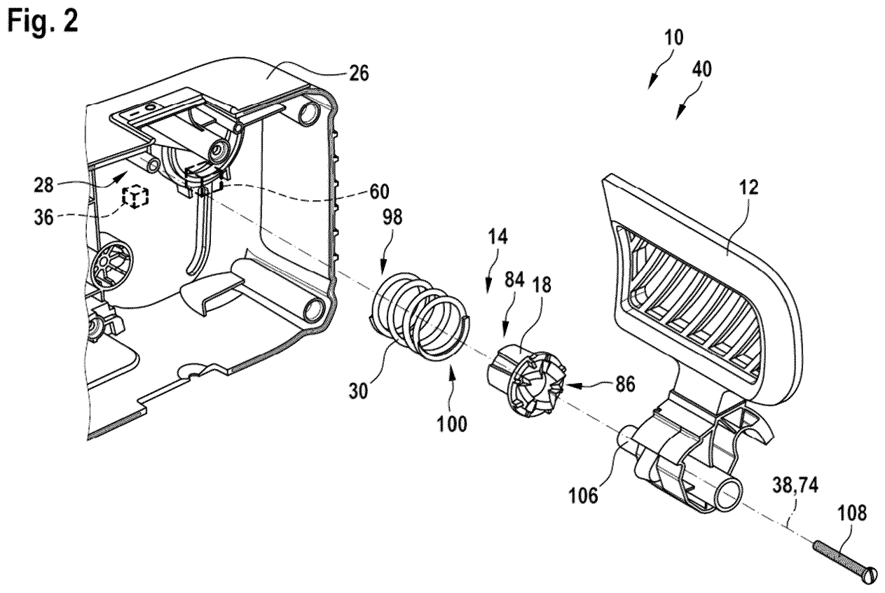

The hand protection lever 12 is disposed between the further handle 56 and the tool mounting area 62. The hand protection lever 12 is provided to actuate a brake of the handheld power tool 10 (not shown here), preferably a chain brake, particularly in the event of an unexpected kick-back of the handheld power tool 10. The brake is preferably provided to bring the tool, in particular the chainsaw to a standstill within fractions of a second, preferably by mechanical and/or electronic means, upon triggering of the brake, for example as a result of a kick-back of the handheld power tool 10. The brake can be triggered by a movement of the hand protection lever 12, in particular by a rotation of the hand protection lever 12 about an axis of rotation 38 of the hand protection lever 12, preferably by a forward rotation of the hand protection lever 12 about the axis of rotation 38 (cf. FIG. 2). The rotation axis 38 is at least substantially perpendicular to a main extension axis of the handheld power tool 10. The handheld power tool 10 has a trigger element 60. The trigger element 60 is actuatable by a forward rotation of the hand protection lever 12 starting from a neutral position by the hand protection lever 12, preferably when the hand protection lever 12 moves to a trigger position of the hand protection lever 12. The trigger element 60 is in particular provided to trigger the brake upon actuation of the trigger element 60. The trigger element 60 is configured as a button or the like. By contacting a hand or an arm of an operator, for example generated by a kickback of the handheld power tool 10, with the hand protection lever 12, a movement of the hand protection lever 12, in particular a forward rotation of the hand protection lever 12, can be generated to trigger the brake, in particular to actuate the trigger element 60. The hand protection lever 12 is rotatably supported on a handheld power tool housing 26 of the handheld power tool 10, in particular rotatably supported about the axis of rotation 38. The forward rotation of the hand protection lever 12 is a rotation of the hand protection lever 12 in the direction of the tool mounting area 62 (see also forward rotation direction 50 of a forward rotation of the hand protection lever 12 in FIG. 1).

The handheld power tool 10 comprises a handheld power tool device 40. The handheld power tool 10, in particular the handheld power tool device 40, comprises a mechanical control unit 14 for controlling the movement of the hand protection lever 12. The movement behavior of the hand protection lever 12 is determined by the control unit 14.

By rotating the hand protection lever 12 forward from the neutral position of the hand protection lever 12, particularly relative to a control element 18 of the control unit 14 by at least 10°, preferably by at least 15°, and preferably by at least 20° about the axis of rotation 38, the hand protection lever 12 can be moved to a trigger position of the hand protection lever 12. The brake can be triggered by moving the hand protection lever 12 to the trigger position. To move the hand protection lever 12 from the neutral position to the trigger position or from the trigger position to the neutral position, an actuating force must be applied to the hand protection lever 12. The actuating force for moving the hand protection lever 12 from the neutral position to the trigger position or from the trigger position to the neutral position at an actuation point 70 of the hand protection lever 12 is between 20 N and 60 N. The actuating point 70 is located at a free end 72 of the hand protection lever 12. A distance of the actuation point 70 to the axis of rotation 38 is preferably between 100 mm and 140 mm, preferably between 110 mm and 130 mm, and particularly preferably 120 mm.

The control unit 14 comprises at least mechanical control element 18. The control element 18 is provided to control rotational movement of hand protection lever 12 by an axial relative movement between the control element 18 and the hand protection lever 12. The axial relative movement between the control element 18 and the hand protection lever 12 is at least parallel to the axis of rotation 38 of the hand protection lever 12. The relative movement between the control element 18 and the hand protection lever 12 takes place along the axis of rotation 38 of the hand protection lever 12. The axis of rotation 38 preferably corresponds to an axial axis of movement 74 of the axial relative movement between the control element 18 and the hand protection lever 12. The hand protection lever 12 is fixed in the axial direction, in particular relative to the handheld power tool housing 26. The control element 18 is movable in the axial direction, in particular relative to the handheld power tool housing 26. Alternatively, it is contemplated that hand protection lever 12 may be movable in the axial direction, particularly relative to handheld power tool housing 26, and the control element 18 may be fixed in the axial direction, in particular relative to handheld power tool housing 26. Further, it is contemplated that the hand protection lever 12 and control element 18 may be movable in the axial direction, particularly relative to the handheld power tool housing 26. Axial movement of the control element 18, in particular, movement of the control element 18 along the axis of rotation 38 can be generated by rotational movement of the hand protection lever 12 about the axis of rotation 38.

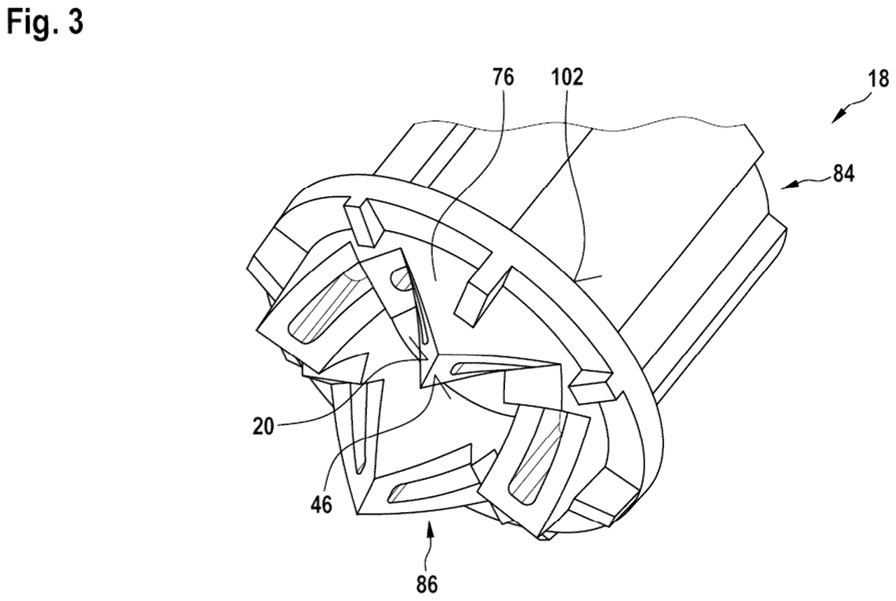

The control element 18 comprises a plurality of control surfaces 20, 46 adapted for axial displacement (in FIG. 3, only a selection of the control surfaces 20, 46 of the control element 18 is provided with reference characters in order to provide a better overview). Alternatively, it is contemplated that the control element 18 may comprise a number of control surfaces 20, 46 different from the number of control surfaces 20, 46 shown herein by way of example, and in particular, at least one control surface 20, 46. Through interaction of at least a portion of the control surfaces 20, 46 with the hand protection lever 12, an axial relative movement can occur between the control element 18 and the hand protection lever 12. The hand protection lever 12 interacts with at least a portion of the control surfaces 20, 46 during a rotational movement of the hand protection lever 12 in order to generate the axial relative movement between the hand protection lever 12 and the control element 18. A respective major extension plane of the control surfaces 20, 46 is inclined, and in particular at an angle other than 90°, to the axis of rotation 38. The control surfaces 20, 46 are planar. Alternatively, however, it is also contemplated that the control surfaces 20, 46 are at least partially curved. Two of the control surfaces 20, 46 in each case are part of a ramp element 76 of the control element 18.

The control element 18 comprises a plurality of ramp elements 76 (only one of the ramp elements 76 is provided with reference numbers in the figures). Alternatively, it is contemplated that the control element 18 may comprise a number of ramp elements 76 other than a number of ramp elements 76 of the control element 18 shown here. The ramp elements 76 are configured as triangular in shape, in particular as two-sided ramps, preferably without a center piece. Two of the control surfaces 20, 46 in each case correspond to sides of the ramps, which are preferably two-sided. The ramp elements 76 and/or the control surfaces 20, 46 are disposed about the axis of rotation 38, particularly about the axial axis of movement 74, preferably evenly. The ramp elements 76 of the control element 18 comprise two different types of ramp elements 76 that differ in a ramp height and a ramp width. The two types of ramp elements 76 are alternately disposed about the axis of rotation 38, particularly about the axial axis of movement 74. The ramp heights of the ramp elements 76 are at least substantially parallel to the axis of rotation 38, in particular to the axial axis of movement 74. The ramp widths of the ramp elements 76 run in a circumferential direction that runs in a plane perpendicular to the axis of rotation 38, particularly the axial axis of movement 74.

The ramp elements 76, in particular, the control surfaces 20, 46 form a zigzag-shaped path, in particular about the axial axis of movement 74 and/or the axis of rotation 38. The respective main extension planes of the control surfaces 20, 46 enclose a corresponding angle with a plane that is perpendicular to the axis of rotation 38, in particular the axial axis of movement 74.

The control unit 14 comprises at least one further mechanical control element 22. The control element 18 and the further control element 22 have complementary control surfaces 20, 24, 42, 44, 46, 48 configured for axial displacement. The further control element 22 comprises a plurality of control surfaces 24, 42, 46, 48 configured for axial displacement (only a selection of the control surfaces 24, 42, 46, 48 of the further control element 22 is provided with reference characters in the figures for better overview). Alternatively, it is contemplated that further control element 22 may comprise a different number of control surfaces 24, 42, 46, 48, than the number of control surfaces 24, 42, 46, 48 as shown herein by way of example.

The further control element 22 comprises a plurality of ramp elements 78, 80 (only two of the ramp elements 78, 80 are provided with reference numerals in the figures). It is alternatively contemplated that the further control element 22 may comprise a number of ramp elements 78, 80 other than a number of ramp elements 78, 80 of the further control element 22 shown herein. The ramp elements 78, 80 of the further control element 22 are configured complementary, in particular analogously, to the ramp elements 76 of the control element 18. The control surfaces 24, 42, 46, 48 of the further control element 22 are configured complementary, in particular analogously, to the control surfaces 20, 46 of the control element 18. The ramp elements 78, 80 of the further control element 22 comprise two different types of ramp elements 78, 80 that differ in a ramp height and a ramp width. The two types of ramp elements 78, 80 are alternately disposed about the axis of rotation 38, in particular about the axial axis of movement 74.

Through rotational movement of the hand protection lever 12, particularly relative to the control element 18, an axial relative movement can be generated between the control element 18 and the hand protection lever 12, in particular the further control element 22, through interaction of the complementary control surfaces 20, 24, 42, 44, 46, 48 of the control element 18 and the further control element 22. Interacting, in particular adjacent control surfaces 20, 24, 42, 44, 46, 48, preferably at least their main extension planes, those of the control element 18 and those of the further control element 22 are at least substantially parallel to one another.

The further control element 22 is connected to the hand protection lever 12 in a rotationally fixed manner. The further control element 22 is formed integrally with at least a portion of the hand protection lever 12. Alternatively, however, it is also conceivable that the further control element 22 is attached to the hand protection lever 12 by means of a screw connection, a latch connection, a clamp connection, a rivet connection, or the like, in particular, in a detachable manner. The further control element 22 is rigidly connected to the hand protection lever 12.

The further control element 22 rotates about the axis of rotation 38 relative to the control element 18 about the axis of rotation 38 during rotation of the hand protection lever 12. A rotation of the further control element 22 relative to the control element 18 generates an axial relative movement between the control element 18 and the hand protection lever 12, in particular the further control element 22, in particular during a rotation of the hand protection lever 12 relative to the control element 18 about the axis of rotation 38.

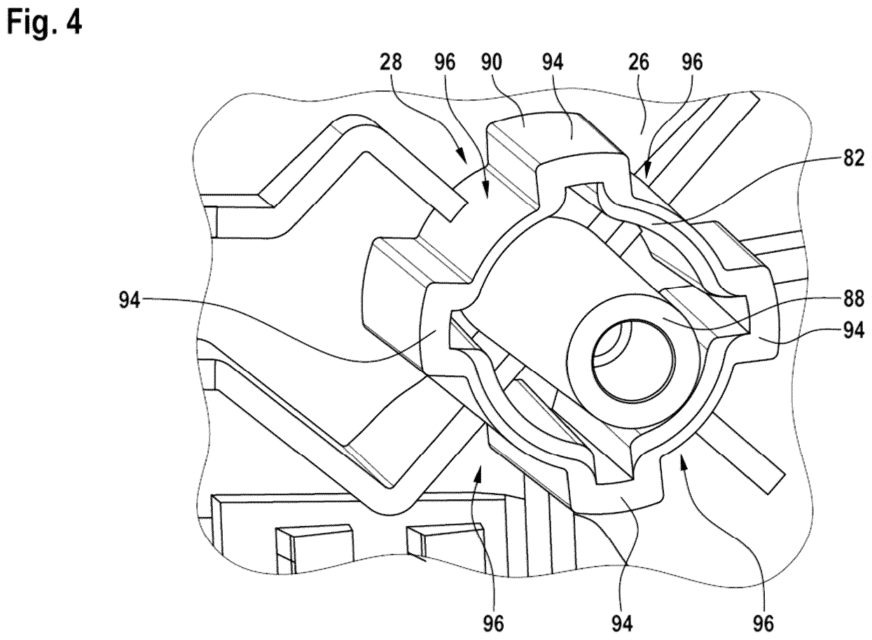

The handheld power tool housing 26 comprises a mounting unit 28 for mounting at least part of the control unit 14 (cf. FIG. 4). The mounting unit 28 is provided for rotationally fixed mounting of the axially movable control element 18. The mounting unit 28 comprises at least one mounting element 82 for the control element 18. The control element 18 is mounted on the handheld power tool housing 26 in a rotationally fixed manner at least in an operating state by way of the mounting element 82, in particular about the axis of rotation 38 and/or the axial axis of movement 74. The control element 18 is movably connected to handheld power tool housing 26 by way of mounting element 82 in the axial direction, in particular along the axis of movement 74, preferably along the axis of rotation 38. The mounting element 82 is formed integrally with at least a portion of the handheld power tool housing 26. Alternatively, it is also contemplated that the mounting element 82 may be secured to the handheld power tool housing 26, in particular, in a detachable manner, by means of a screw connection, a latch connection, a clamped connection, a rivet connection, or the like.

The mounting element 82 has a shape complementary to a free end 84 of the control element 18. The control surfaces 20, 46 of control element 18 and/or the ramp elements 76 of control element 18 are disposed at a further free end 86 of control element 18. The free end 84 of the control element 18 is disposed facing away from the further free end 86 of the control element 18. The control element 18 is connected to the mounting unit 28, in particular the mounting element 82, on a side facing away from the control surfaces 20, 46 of the control element 18 and/or the ramp elements 76 of control element 18.

The mounting unit 28 comprises at least one further mounting element 88 for the hand protection lever 12. The hand protection lever 12 is mounted rotatably on the handheld power tool housing 26 by way of the further mounting element 88, particularly via a mounting sleeve 106 of the hand protection lever 12, in particular about the axis of rotation 38 and/or the axial axis of movement 74. The hand protection lever 12 is fastened to the handheld power tool housing 26 by means of a fastening element 108, preferably via the mounting sleeve 106. The fastening element 108 is configured as a screw. Alternatively, it is contemplated that the fastening element 108 may be formed as a rivet or the like, and/or that the hand protection lever 12 may be fixed to the handheld power tool housing 26 by means of a clamped connection, a latch connection, or the like, preferably via the mounting sleeve 106. The hand protection lever 12 is fixed to the handheld power tool housing 26 by way of the further mounting element 88 in the axial direction, in particular along the axis of movement 74, preferably along the axis of rotation 38. The further mounting element 88 is formed integrally with at least a portion of the handheld power tool housing 26. Alternatively, it is also contemplated that the further support element 88 is secured to the handheld power tool housing 26 by means of a screw connection, a latch connection, a clamp connection, a rivet connection, or the like, in particular, in a detachable manner.

The mounting unit 28 specifies at least one arrangement angle of the control element 18 to the mounting unit 28. The mounting unit 28, preferably the mounting element 82, allows for mounting of the control element 18 on the mounting unit 28 only in one or more angular positions of the control element 18 relative to the mounting unit 28, in particular the mounting element 82. The mounting element 82 comprises a mounting contour 90 that is in particular complementary to a mounting connection contour 92 of the control element 18. The mounting contour 90 of the mounting element 82 permits assembly of the control element 18 only in one or more angular positions of the control element 18 relative to the mounting unit 28, in particular the mounting element 82. The mounting element 82, in particular the mounting contour 90, comprises one or more protrusions 94, one or more recesses 96, a combination thereof, or the like.

The control unit 14 is provided to permit forward rotation and reverse rotation of the hand protection lever 12 relative to the control element 18 starting from the neutral position of the hand protection lever 12. The reverse rotation of the hand protection lever 12 is a rotation of the hand protection lever 12 in a direction opposite to forward rotation of the hand protection lever 12. The reverse rotation of the hand protection lever 12 is a rotation of the hand protection lever 12 in a direction away from the tool mounting area 62. The reverse rotation of the hand protection lever 12 is a rotation of the hand protection lever 12 towards the handle 54 and/or the further handle 56 (see also reverse rotation direction 52 of a reverse rotation of the hand protection lever 12 in FIG. 1). The reverse rotation of the hand protection lever 12 is rotation of the hand protection lever 12 about the axis of rotation 38.

The control unit 14 comprises at least one spring element 30. The spring element 30 is configured as a single coil spring. Alternatively, it is also contemplated that the spring element 30 is configured as a torsion spring, a rubber elastic element, or the like. The control unit 14 comprises exactly one, in particular the spring element 30 already mentioned above. Alternatively, however, it is also contemplated that the control unit 14 comprises a plurality of spring elements 30, in particular to apply a force to the control element 18 in the direction of the hand protection lever 12.

The spring element 30 is provided to apply a force to the control element 18 in the direction of the hand protection lever 12. The spring element 30 is disposed between control element 18 and handheld power tool housing 26 at least in an operating state. The spring element 30 abuts the handheld power tool housing 26, in particular with a free end 98 of the spring element 30. The spring element 30 abuts the control element 18, particularly with a further free end 100 of the spring element 30, and preferably abuts an abutment surface 102 of the control element 18. The free end 98 of the spring element 30 is disposed facing away from the further free end 100 of the spring element 30. A major extension plane of the abutment surface 102 is at least substantially perpendicular to the axis of rotation 38 and/or the axis of movement 74.

A movement of the control element 18 along the axial axis of movement 74, particularly along the axis of rotation 38, generates a compression or elongation of the spring element 30. An axis of elongation and/or compression of the spring element 30 is at least substantially parallel to the axis of rotation 38 and/or the axial axis of movement 74 at least in an operating state. To rotate the hand protection lever 12, an actuating force must be applied opposite to the spring force that can be generated by the spring element 30.

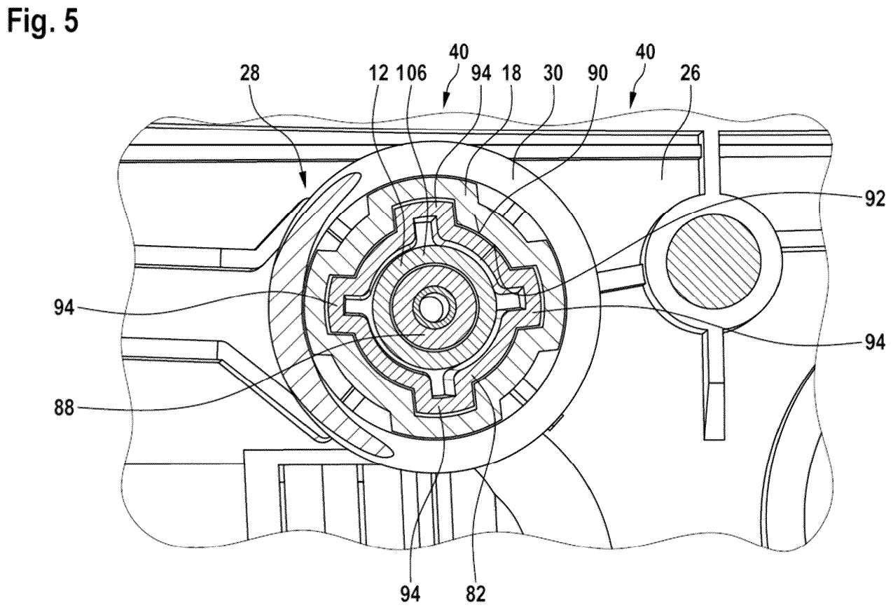

The spring element 30 surrounds the control element 18 in at least one operating state at least in part, preferably at least substantially entirely, preferably entirely, particularly when viewed in a direction parallel to the axis of rotation 38 (cf. FIG. 5). The spring element 30 encompasses the mounting element 82 and/or the further mounting element 88 at least in an operating state at least partially, preferably at least substantially completely and particularly completely, particularly when viewed in the direction parallel to the axis of rotation 38, in particular the axis of movement 74. The spring element 30 completely encloses the mounting sleeve 106 of the hand protection lever 12, in particular at least when viewed in the direction parallel to the axis of rotation 38, in particular the axis of movement 74.

The spring element 30 automatically moves the hand protection lever 12 to the neutral position after a reverse rotation of the hand protection lever 12 starting from the neutral position of the hand protection lever 12. Complementary control surfaces 20, 24, 42, 44, 46, 48 of control element 18 and further control element 22 are arranged such that an automatic movement of the hand protection lever 12 to the neutral position from the neutral position of the hand protection lever 12 is generated by means of the spring element 30 after reverse rotation of the hand protection lever 12.

The control unit 14 comprises a stop element 32. The stop element 32 is provided to limit reverse rotation of the hand protection lever 12 from the neutral position. The stop element 32 is provided to limit a reverse rotation of the hand protection lever 12 from the neutral position through an impact of the hand protection lever 12 on the stop element 32. Alternatively, it is contemplated that a reverse rotation of the hand protection lever 12 starting from the neutral position is limited by the control element 18 impacting against the stop element 32. An outer wall 34 of the handheld power tool housing 26 comprises the stop element 32, which is provided to limit a reverse rotation of the hand protection lever 12 starting from a neutral position of the hand protection lever 12. The stop element 32 is configured as a stop edge. The hand protection lever 12 comprises a stop surface 58 that is complementary to the stop element 32.

The stop element 32 defines a stop position of the hand protection lever 12. The neutral position is in particular different from the trigger position and/or the stop position. The neutral position is disposed between the trigger position and the neutral position. The neutral position and/or the trigger position are/is stationary positions of the hand protection lever 12. To move the hand protection lever 12 from a stationary position of the hand protection lever 12, preferably the trigger position or the neutral position, an actuating force is to be applied to the hand protection lever 12. The stationary positions of the hand protection lever 12, in particular the trigger position and/or the neutral position, are defined by the control unit 14, in particular the complementary control surfaces 20, 24, 42, 44, 46, 48 of the control element 18 and the further control element 22.

The handheld power tool 10 comprises at least one actuating element 36, in particular a shift element, for triggering a handheld power tool function, in particular a safety function. The actuating element 36 can be actuated by a reverse rotation of the hand protection lever 12 starting from a neutral position of the hand protection lever 12. For example, the handheld power tool function may be an additional activation level for a commissioning of the handheld power tool 10, a safety function, for example a trigger for the brake, an automatic system check of the handheld power tool 10, or the like. The actuating element 36 can be actuated upon reverse rotation of the hand protection lever 12 starting from the neutral position by the hand protection lever 12, for example by a protrusion of the hand protection lever 12 or the like.

The actuation element 36 can be actuated from the neutral position of the hand protection lever 12 by a reverse rotation of hand protection lever 12 to the stop element 32. It is contemplated that the actuating element 36 may be disposed on the stop element 32 or spaced apart from the stop element 32. The actuating element 36 is configured as a button, a lever, a gear element or the like, for example.

At least the control element 18 is disposed at least in a nearby region of an axis of rotation 38 of the hand protection lever 12. The control element 18 is disposed closed about axis of rotation 38. The control element 18 encloses the axis of rotation 38 at least substantially completely, preferably completely, particularly when viewed in the direction parallel to the axis of rotation 38.

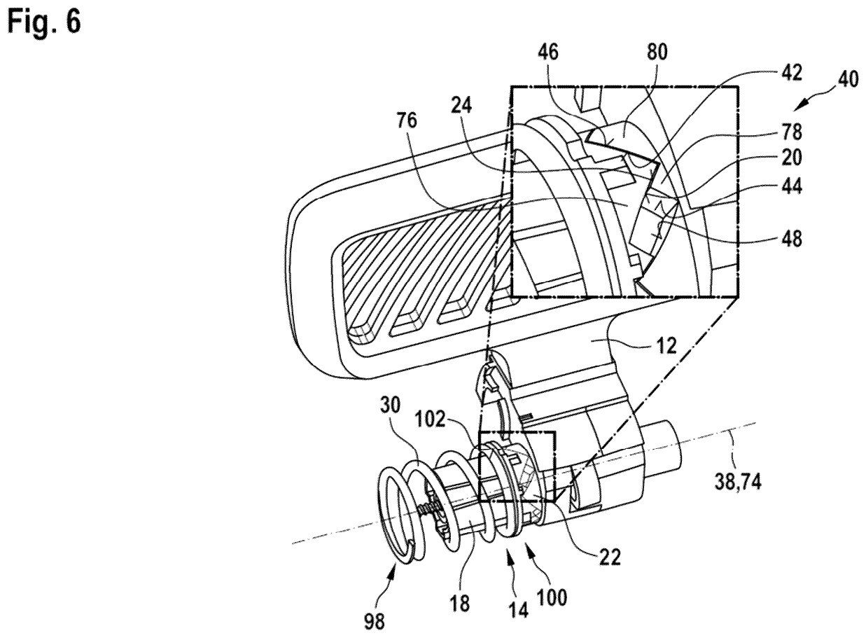

FIG. 6 shows the hand protection lever 12 in the neutral position. A control surface 24 of the further control element 22 abuts a control surface 20 of the control element 18 in the neutral position. A further control surface 42 of the further control element 22 abuts a further control surface 46 of the control element 18. The ramp element 76 of the control element 18 is in a depression defined by the control surface 24 of the further control element 22 and the further control surface 42 of the further control element 22 in the neutral position, in particular when stationary.

As a result of a forward rotation of the hand protection lever 12 from the neutral position about the axis of rotation 38, the ramp element 76 of the control element 18 moves against a ramp element 78 of the ramp elements 78, 80 of the further control element 22, in particular, the control surface 20 of the control element 18 moves against the control surface 24 of the further control element 22, whereby the control element 18 moves in the axial direction relative to the hand protection lever 12, preferably against to the spring force that can be generated by the spring element 30.

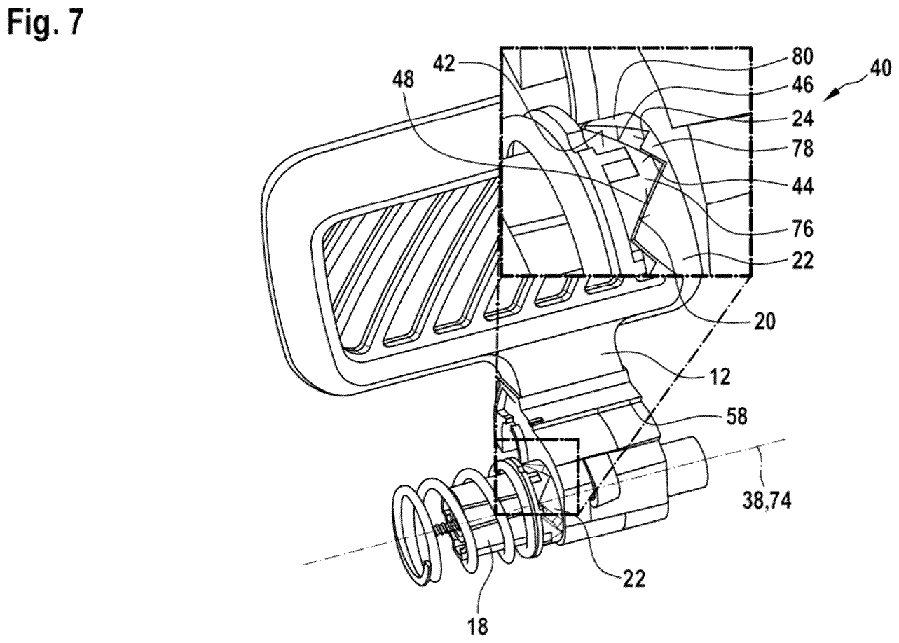

If a tip of the ramp element 76 crosses a tip of the ramp element 78 due to a forward rotation of the hand protection lever 12, in particular starting from the neutral position, the hand protection lever 12 moves to the trigger position of the hand protection lever 12 (cf. FIG. 7). In the trigger position, the control surface 20 of the control element 18 abuts an additional control surface 48 of the further control element 22. In the trigger position, the further control surface 46 of the control element 18 abuts a further additional control surface 44 of the further control element 22. The ramp element 76 of the control element 18 is in a depression defined by the additional control surface 48 of the further control element 22 and the further additional control surface 44 of the further control element 22 in the trigger position, in particular when stationary.

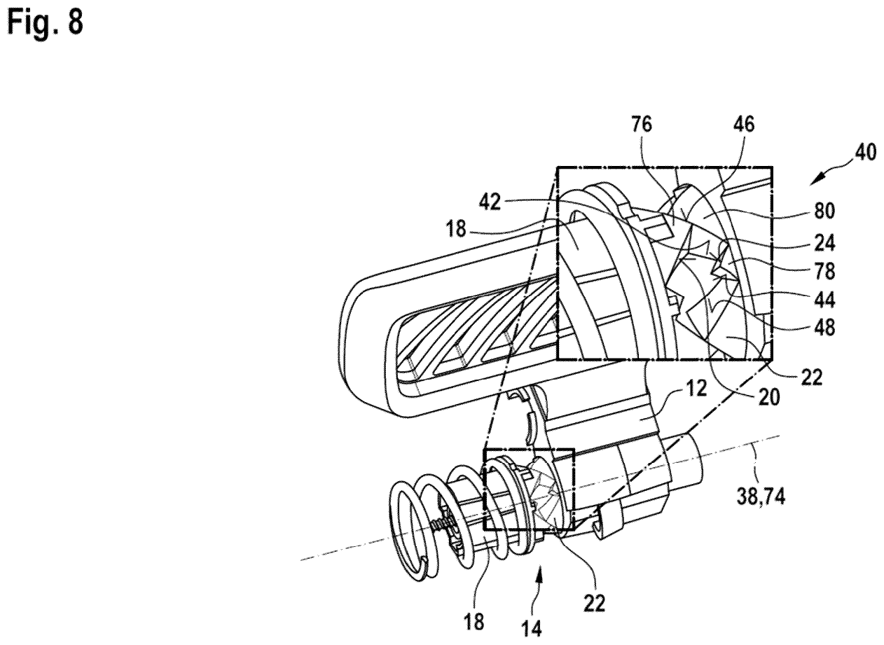

As a result of a reverse rotation of the hand protection lever 12 from the neutral position about the axis of rotation 38, the ramp element 76 of the control element 18 moves against a further ramp element 80 of the ramp elements 78, 80 of the further control element 22, in particular, the further control surface 46 of the control element 18 moves against the further control surface 42 of the further control element 22, whereby in particular the control element 18 moves in the axial direction relative to the hand protection lever 12, preferably against to the spring force that can be generated by the spring element 30. During a reverse rotation of the hand protection lever 12 from the neutral position about the axis of rotation 38, the ramp element 76 of the control element 18 moves against the further ramp element 80 of the ramp elements 78, 80 of the further control element 22, in particular, the further control surface 46 of the control element 18 moves against the further control surface 42 of the further control element 22 until the hand protection lever 12 impacts the stop element 32. If the hand protection lever 12 impacts the stop element 32, the hand protection lever 12 is in the stop position (cf. FIG. 8). The stop position is different from a stationary position of the hand protection lever 12. The control unit 14 is provided to automatically move the hand protection lever 12 from the stop position by means of the spring element 30 to the neutral position, in particular when the hand protection lever 12 is free of a correspondingly counteracting actuating force, for example by an operator or another load.

The ramp element 78 of further control element 22, which in particular is to be crossed to move the hand protection lever 12 from the neutral position to the trigger position or from the trigger position to the neutral position, is smaller than the further ramp element 80 of the further control element 22. In particular, a ramp height and/or ramp width of the ramp element 78 of the further control element 22 is less than a ramp height and/or ramp width of the ramp element 80 of the further control element 22.

1. A handheld power tool, comprising:
a hand protection lever; and
at least one mechanical control unit configured to control movement of the hand protection lever of the handheld power tool,
wherein the control unit comprises at least one mechanical control element which is configured to control a rotational movement of the hand protection lever by an axial relative movement between the control element and the hand protection lever.

2. The handheld power tool according to claim 1, wherein the control element comprises at least one control surface configured for axial displacement.

3. The handheld power tool according to claim 1, wherein the control unit comprises at least one further mechanical control element, wherein the control element and the further control element have complementary control surfaces configured for axial displacement, and wherein the further control element is connected to the hand protection lever in a rotationally fixed manner.

4. The handheld power tool according to claim 1, further comprising a handheld power tool housing including at least one mounting unit for mounting at least part of the control unit for rotationally fixed mounting of the axially movable control element.

5. The handheld power tool of claim 4, wherein the mounting unit specifies at least one arrangement angle of the control element to the mounting unit.

6. The handheld power tool according to claim 1, wherein the control unit is configured to permit forward rotation and reverse rotation of the hand protection lever relative to the control element starting from a neutral position of the hand protection lever.

7. The handheld power tool according to claim 1, wherein the control unit comprises at least one spring element which is configured to apply a force to the control element in the direction of the hand protection lever, and wherein the spring element at least partially encloses the control element in at least one operating state.

8. The handheld power tool according to claim 6, wherein the spring element is configured to automatically move the hand protection lever to the neutral position after a reverse rotation of the hand protection lever starting from a neutral position of the hand protection lever.

9. The handheld power tool according to claim 1, wherein the control unit comprises a stop element which is configured to limit a reverse rotation of the hand protection lever starting from a neutral position of the hand protection lever by an impact of the hand protection lever against the stop element.

10. The handheld power tool according to claim 9, further comprising a handheld power tool housing, wherein an outer wall of the handheld power tool housing comprises the stop element.

11. The handheld power tool according to claim 1, further comprising at least one actuating element which is configured to trigger a handheld power tool function which is actuated by a reverse rotation of the hand protection lever starting from a neutral position of the hand protection lever.

12. The handheld power tool according to claim 9, wherein the actuating element is configured to be actuated from the neutral position of the hand protection lever by a reverse rotation of the hand protection lever to the stop element.

13. The handheld power tool according to claim 1, wherein the at least the control element is disposed at least in a nearby region of an axis of rotation of the hand protection lever.

14. A handheld power tool device for a handheld power tool, comprising:
at least one mechanical control unit configured to control movement of a hand protection lever of the handheld power tool,
wherein the control unit comprises at least one mechanical control element which is configured to control a rotational movement of the hand protection lever by an axial relative movement at least substantially along an axis of rotation of the hand protection lever between the control element and the hand protection lever.

15. The handheld power tool according to claim 1, wherein the handheld power tool is a chain saw.

16. The handheld power tool according to claim 1, wherein the control unit comprises at least one coil spring which is configured to apply a force to the control element in the direction of the hand protection lever, and wherein the coil spring at least partially encloses the control element in at least one operating state.

17. The handheld power tool according to claim 1, further comprising a switching element configured to trigger a safety function which is actuated by a reverse rotation of the hand protection lever starting from a neutral position of the hand protection lever.

18. The handheld power tool according to claim 1, wherein the at least the control element is disposed at least in a nearby region of an axis of rotation of the hand protection lever closed about the axis of rotation.

19. The handheld power tool according to claim 14, wherein the handheld power tool is a chain saw.
